(19) United States
(12) Patent Application Publication
(10) Pub. No.: US 2022/0366259 A1
(43) Pub. Date: Nov. 17, 2022

(54) METHOD, APPARATUS AND SYSTEM FOR TRAINING A NEURAL NETWORK, AND STORAGE MEDIUM STORING INSTRUCTIONS

(71) Applicant: CANON KABUSHIKI KAISHA, Tokyo (JP)

(72) Inventors: Deyu Wang, Beijing (CN); Tse-wei Chen, Tokyo (JP); Dongchao Wen, Beijing (CN); Junjie Liu, Beijing (CN); Wei Tao, Beijing (CN)

(21) Appl. No.: 17/765,711

(22) PCT Filed: Oct. 30, 2020
(86) PCT No.: PCT/JP2020/040824

§ 371 Date: Mar. 31, 2022

(30) Foreign Application Priority Data
Nov. 8, 2019 (CN) 201911086516.1

(51) Int. Cl. G06N 3/08; G06N 3/04

(52) U.S. Cl. CPC G06N 3/082; G06N 3/0454

(57) ABSTRACT

Provided are a method, an apparatus and a system for training a neural network, and a storage medium storing instructions. The neural network comprises a first neural network and a second neural network, training of the first neural network has not yet completed and training of the second neural network does not start. The method comprises: obtaining a first output by subjecting a sample image to the current first neural network, and obtaining a second output by subjecting the sample image to the current second neural network; and updating the current first neural network according to a first loss function value, and updating the current second neural network according to a second loss function value. The performance of the second neural network can be improved, and the overall training time of the first neural network and the second neural network can be reduced.

### TECHNICAL FIELD

The present invention relates to image processing, and in particularly to a method, an apparatus and a system for training a neural network, and a storage medium storing instructions, for example.

### BACKGROUND ART

At present, a guided learning algorithm (e.g. knowledge distilling algorithm) is widely used in deep learning, such that a light-weight neural network (commonly referred to as “student neural network”) with a weaker learning ability can learn more experience from a deep neural network (commonly referred to as “teacher neural network”) with a stronger learning ability, thereby improving the performance of the student neural network. In general, in a process of training a neural network, the teacher neural network is trained in advance, and then the student neural network imitates and learns the teacher neural network to complete the corresponding training operations.

NPL 1 discloses an exemplary method in which the student neural network imitates and learns the teacher neural network. In the exemplary method, an operation that the student neural network imitates and learns the teacher neural network is performed based on features obtained by subjecting a sample image to the trained teacher neural network. The specific operations are as follows: 1) an operation of generating an imitated area: iteratively calculating an Intersection-over-Union (IoU) of an object area in a label of the sample image to a pre-set anchor box area, and generating the imitated area by combining anchor box areas in which the IoU is larger than a factor F (i.e., filter threshold value); and 2) an operation of training the student neural network: guiding an update of the student neural network based on features in the imitated area among the features obtained by subjecting the sample image to the trained teacher neural network, thereby making feature distribution of the student neural network in the imitated area closer to feature distribution of the teacher neural network.

### CITATION LIST

### Non Patent Literature

NPL 1: Distilling Detectors with Fine-grained Feature Imitation (Tao Wang, Li Yuan, Xiaopeng Zhang, Jiashi Feng; CVPR 2019)

As can be known from the above, in the general guided learning method, it is required to complete training of the teacher neural network in advance, and then guide training of the student neural network using the trained teacher neural network, which will require plenty of training time to complete training of the teacher neural network and the student neural network. In addition, since the teacher neural network has already been trained in advance, it is impossible for the student neural network to learn the relevant experience in the process of training the teacher neural network well, thereby affecting the performance of the student neural network.

### SUMMARY OF INVENTION

In view of the recordation in the above Related Art, the present disclosure is directed to solve at least one of the above problems.

According to an aspect of the present disclosure, there is provided a method of training a neural network comprising a first neural network and a second neural network, characterized in that: training of the first neural network has not yet completed and training of the second neural network does not start, wherein for the current first neural network and the current second neural network, the method comprises: an output step of obtaining a first output by subjecting a sample image to the current first neural network, and obtaining a second output by subjecting the sample image to the current second neural network; and an update step of updating the current first neural network according to a first loss function value, and updating the current second neural network according to a second loss function value, wherein the first loss function value is obtained according to the first output, and the second loss function value is obtained according to the first output and the second output.

According to another aspect of the present disclosure, there is provided an apparatus for training a neural network comprising a first neural network and a second neural network, characterized in that: training of the first neural network has not yet completed and training of the second neural network does not start, wherein for the current first neural network and the current second neural network, the apparatus comprises: an output unit for obtaining a first output by subjecting a sample image to the current first neural network, and obtaining a second output by subjecting the sample image to the current second neural network; and an update unit for updating the current first neural network according to a first loss function value, and updating the current second neural network according to a second loss function value, wherein the first loss function value is obtained according to the first output, and the second loss function value is obtained according to the first output and the second output.

According to a further aspect of the present disclosure, there is provided a system for training a neural network comprising a cloud server and an embedded device that are connected to each other via a network, the neural network comprising a first neural network for which training is executed in the cloud server, and a second neural network for which training is executed in the embedded device, characterized in that: training of the first neural network has not yet completed and training of the second neural network does not start, wherein for the current first neural network and the current second neural network, the system executes: an output step of obtaining a first output by subjecting a sample image to the current first neural network, and obtaining a second output by subjecting the sample image to the current second neural network; and an update step of updating the current first neural network according to a first loss function value, and updating the current second neural network according to a second loss function value, wherein the first loss function value is obtained according to the first output, and the second loss function value is obtained according to the first output and the second output.

According to another further aspect of the present disclosure, there is provided a storage medium storing instructions that, when executed by a processor, enable to execute training of a neural network, the neural network comprising a first neural network and a second neural network, characterized in that: training of the first neural network has not yet completed and training of the second neural network does not start, wherein for the current first neural network and the current second neural network, the instructions comprise: an output step of obtaining a first output by subjecting a sample image to the current first neural network, and obtaining a second output by subjecting the sample image to the current second neural network; and an update step of updating the current first neural network according to a first loss function value, and updating the current second neural network according to a second loss function value, wherein the first loss function value is obtained according to the first output, and the second loss function value is obtained according to the first output and the second output.

Wherein, in the present disclosure, the current first neural network has been updated once at most with respect to its previous state. The current second neural network has been updated once at most with respect to its previous state. In other words, each update operation of the first neural network and each update operation of the second neural network is executed in parallel at the same time, which enables the second neural network imitate and learn the training process of the first neural network on a step-by-step basis.

Wherein, in the present disclosure, the first output is to, for example, obtain a first processing result and/or a first sample feature by subjecting the sample image to the current first neural network. The second output is to, for example, obtain a second processing result and/or a second sample feature by subjecting the sample image to the current second neural network.

Wherein, in the present disclosure, the first neural network is for example a teacher neural network, and the second neural network is for example a student neural network.

According to another further aspect of the present disclosure, there is provided a method of training a neural network comprising a first neural network and a second neural network, wherein training of the first neural network has completed and training of the second neural network does not start, characterized in that: for the current second neural network, the method comprises: an output step of obtaining a first sample feature by subjecting a sample image to the first neural network, and obtaining a second sample feature by subjecting the sample image to the current second neural network; and an update step of updating the current second neural network according to a loss function value, wherein the loss function value is obtained according to features in a specific area of the first sample feature and features in the specific area of the second sample feature; wherein, the specific area is determined according to an object area in a label of the sample image; wherein, the specific area is adjusted according to feature values of the second sample feature. Wherein, the specific area is one of the object area, a smooth response area of the object area, and a smooth response area at a corner point of the object area. Wherein, the first neural network is for example a teacher neural network, and the second neural network is for example a student neural network.

As can be known from the above, in the process of training the neural network, the student neural network (i.e., the second neural network) for which training does not start is trained together with the teacher neural network (i.e., the first neural network) for which training does not start or has not yet completed in parallel at the same time in the present disclosure, thereby enabling to supervise and guide training of the student neural network using the training process of the teacher neural network. In the present disclosure, on one hand, since training processes of the teacher neural network and the student neural network are executed in parallel at the same time, the student neural network understands the training process of the teacher neural network more fully, thereby effectively improving the performance (e.g. accuracy) of the student network. On the other hand, since there is no need to train the teacher neural network in advance, but it is trained together with the student neural network in parallel at the same time, the overall training time of the teacher neural network and the student neural network can be reduced greatly.

Further features and advantages of the present disclosure will become apparent from the following description of typical embodiments with reference to the attached drawings.

### BRIEF DESCRIPTION OF DRAWINGS

The accompanying drawings, which are incorporated in and constitute a part of the specification, illustrate embodiments of the present disclosure and, together with the description of the embodiments, serve to explain the principles of the present disclosure.

FIG. 1 is a block diagram schematically illustrating a hardware configuration which is capable of implementing a technique according to an embodiment of the present disclosure.

FIG. 2 is a configuration block diagram schematically illustrating an apparatus for training a neural network according to an embodiment of the present disclosure.

FIG. 3 is a flow chart schematically illustrating a method of training a neural network according to an embodiment of the present disclosure.

FIG. 4 schematically illustrates one flow chart of an update step S320 as shown in FIG. 3 according to an embodiment of the present disclosure.

FIG. 5 schematically illustrates one flow chart of calculating a first loss function value in step S321 as shown in FIG. 4 according to an embodiment of the present disclosure.

FIG. 6 schematically illustrates one flow chart of calculating a second loss function value in step S321 as shown in FIG. 4 according to an embodiment of the present disclosure.

FIG. 7 schematically illustrates an example of obtaining a final first loss function value and a final second loss function value via the current teacher neural network and the current student neural network according to an embodiment of the present disclosure.

FIG. 8 schematically illustrates one flow chart of step S510 as shown in FIGS. 5 and 6 according to an embodiment of the present disclosure.

FIG. 9A schematically illustrates a process example of obtaining a foreground response area by a flow as shown in FIG. 8 according to an embodiment of the present disclosure.

FIG. 9B schematically illustrates a process example of obtaining a foreground response area by a flow as shown in FIG. 8 according to an embodiment of the present disclosure.

FIG. 9C schematically illustrates a process example of obtaining a foreground response area by a flow as shown in FIG. 8 according to an embodiment of the present disclosure.

FIG. 9D schematically illustrates a process example of obtaining a foreground response area by a flow as shown in FIG. 8 according to an embodiment of the present disclosure.

FIG. 9E schematically illustrates a process example of obtaining a foreground response area by a flow as shown in FIG. 8 according to an embodiment of the present disclosure.

FIG. 10 schematically illustrates a process example of obtaining an excitation and suppression area according to an embodiment of the present disclosure.

FIG. 11 is a flow chart schematically illustrating one exemplary method for training a neural network for detecting an object according to an embodiment of the present disclosure.

FIG. 12 schematically illustrates an example of, in a process of training a neural network for detecting an object as shown in FIG. 11, calculating a final first loss function value and a final second loss function value in a case where the specific area determined in step S1130 is the excitation and suppression area.

FIG. 13 is a flow chart schematically illustrating one exemplary method for training a neural network for detecting classification according to an embodiment of the present disclosure.

FIG. 14 is a configuration block diagram schematically illustrating a system for training a neural network according to an embodiment of the present disclosure.

FIG. 15 is a flow chart schematically illustrating another method of training a neural network according to an embodiment of the present disclosure.

### DESCRIPTION OF EMBODIMENTS

Exemplary embodiments of the present disclosure will be described in detail below with reference to the drawings. It should be noted that the following description is illustrative and exemplary in nature and is in no way intended to limit the disclosure, its application or uses. The relative arrangement of the components and steps, the numerical expressions, and numerical values set forth in these embodiments do not limit the scope of the present disclosure unless it is specifically stated otherwise. In addition, the techniques, methods and devices known by persons skilled in the art may not be discussed in detail, however, they shall be a part of the present specification under a suitable circumstance.

It is noted that, similar reference numbers and letters refer to similar items in the drawings, and thus once an item is defined in one figure, it may not be discussed in the following figures.

In a guided learning algorithm (e.g. a knowledge distilling algorithm), since a student neural network (i.e., a second neural network) has a weaker learning ability, it is impossible for the student neural network to fully imitate and learn experience of the teacher neural network (i.e., the first neural network) which has been trained in advance if the teacher neural network is directly used to guide training of the student neural network. The inventors deem that if the training process of the teacher neural network can be introduced to supervise and guide training of the student neural network, the student neural network is enabled to fully understand and learn the experience that the teacher neural network learns step by step, the performance of the student neural network is closer to the teacher neural network. Thus, the inventors deem that in the process of training the neural network, it is unnecessary to train the teacher neural network in advance, but to train the student neural network for which training does not start and the teacher neural network for which training does not start or training has not yet completed in parallel at the same time, thereby realizing to supervise and guide training of the student neural network by the training process of the teacher neural network. Wherein, for the current one update training of the teacher neural network and the student neural network, for example, the current output (e.g. processing result and/or sample feature) of the teacher neural network can be used as real information for training the student neural network this time, thereby supervising and guiding the update of the student neural network. Since the real information for updating and training the student neural network contains constantly-updated optimization process information of the teacher neural network, the performance of the student neural network also becomes more robust.

As stated above, in the process of training the neural network, the student neural network for which training does not start is trained together with the teacher neural network for which training does not start or training has not yet completed in parallel at the same time in the present disclosure, thereby supervising and guiding training of the student neural network using the training process of the teacher neural network. Therefore, according to the present disclosure, on one hand, since training processes of the teacher neural network and the student neural network are executed in parallel at the same time, the student neural network can understand the training process of the teacher neural network more fully, thereby improving the performance (e.g. accuracy) of the student neural network effectively. On the other hand, since it is unnecessary to train the teacher neural network in advance, but it is trained together with the student neural network in parallel at the same time, the overall training time of the teacher neural network and the student neural network can be reduced greatly. Hereinafter, the present disclosure will be described in detail with reference to the accompanying drawings.

### Hardware Configuration

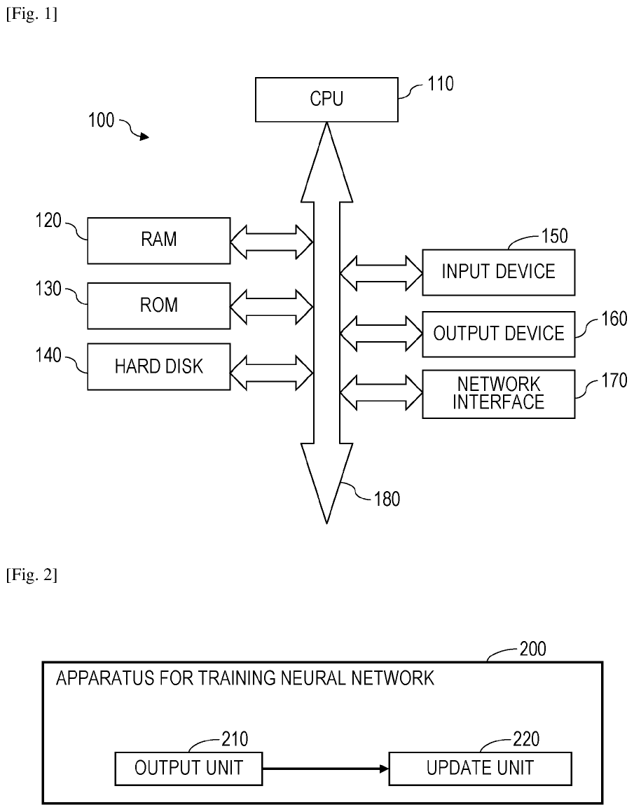

At first, the hardware configuration capable of implementing the technique described below will be described with reference to FIG. 1.

The hardware configuration 100 includes for example a central processing unit (CPU) 110, a random access memory (RAM) 120, a read only memory (ROM) 130, a hard disk 140, an input device 150, an output device 160, a network interface 170 and a system bus 180. In one implementation, the hardware configuration 100 can be implemented by a computer such as a tablet computer, a laptop, a desktop or other suitable electronic devices.

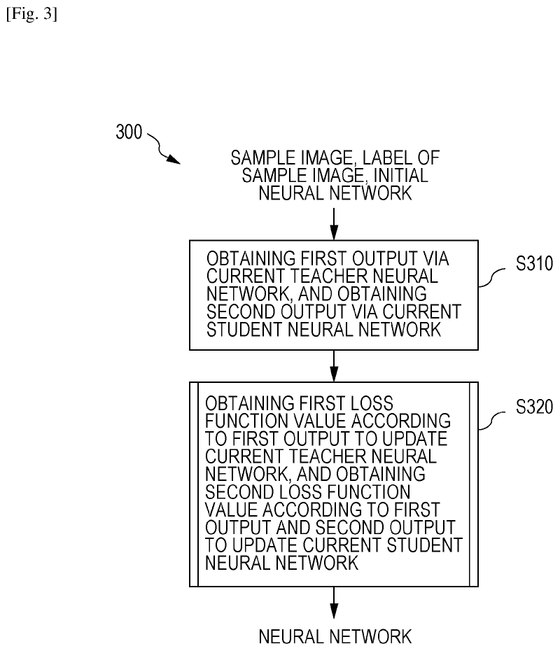

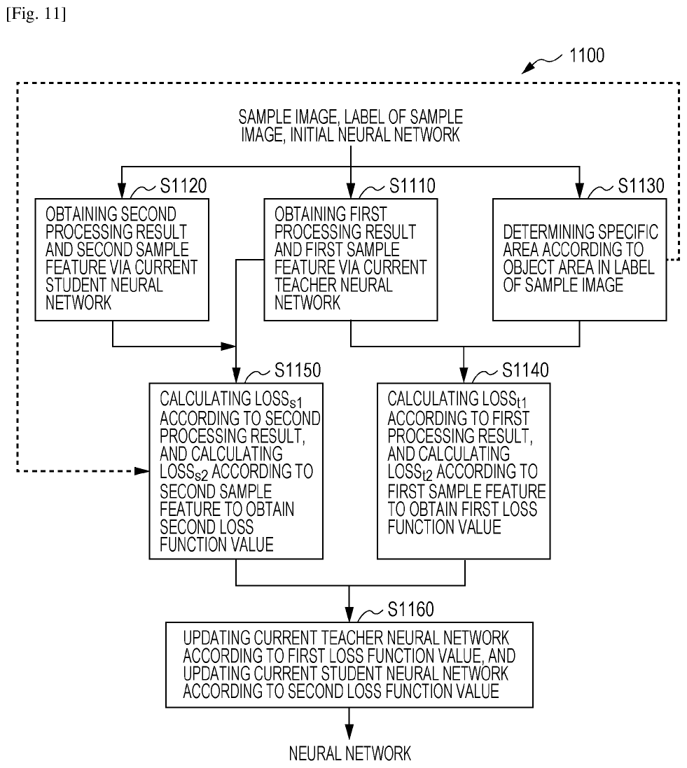

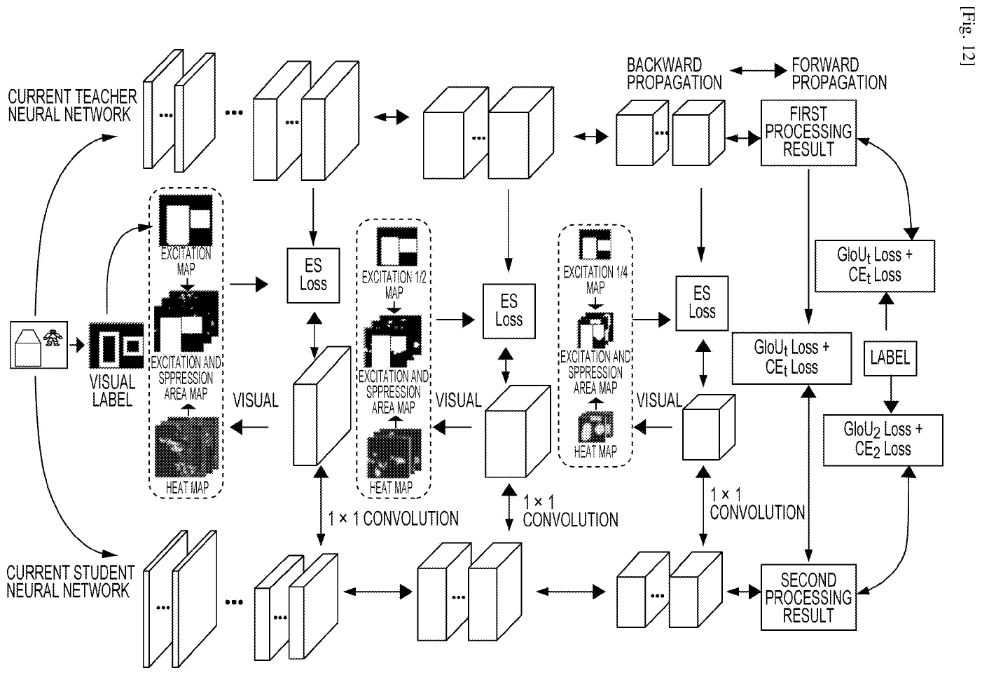

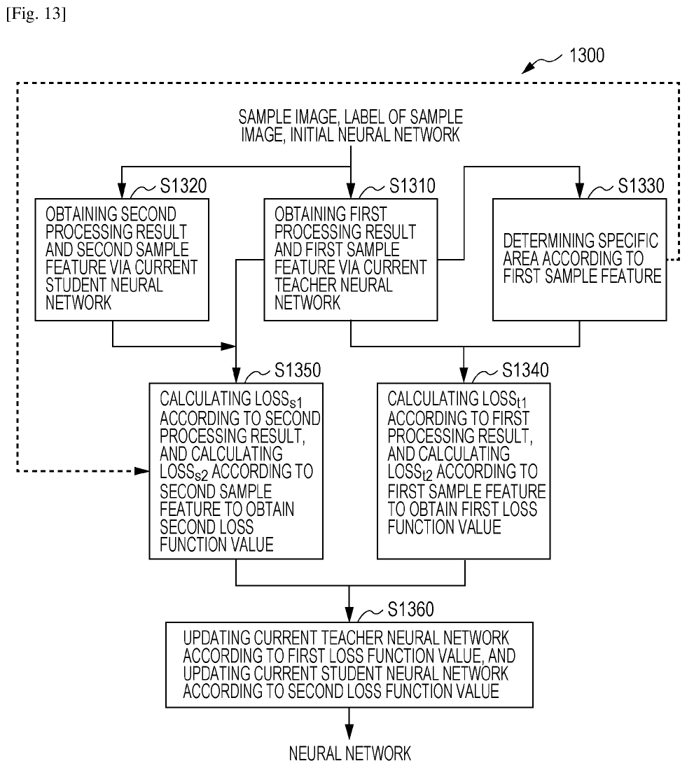

In one implementation, the apparatus for training the neural network according to the present disclosure is configured by hardware or firmware, and serves as modules or components of the hardware configuration 100. For example, the apparatus 200 for training the neural network that will be described in detail below with reference to FIG. 2 serves as modules or components of the hardware configuration 100. In another implementation, the method of training the neural network according to the present disclosure is configured by software which is stored in the ROM 130 or the hard disk 140 and is executed by the CPU 110. For example, the procedure 300 that will be described in detail below with reference to FIG. 3, the procedure 1100 that will be described in detail below with reference to FIG. 11, the procedure 1300 that will be described in detail below with reference to FIG. 13 and the procedure 1500 that will be described in detail below with reference to FIG. 15 serve as a program stored in the ROM 130 or the hard disk 140.

The CPU 110 is any suitable programmable control device (e.g. a processor) and can execute various kinds of functions to be described below by executing various kinds of application programs stored in the ROM 130 or the hard disk 140 (e.g. a memory). The RAM 120 is used to temporarily store programs or data loaded from the ROM 130 or the hard disk 140, and is also used as a space in which the CPU 110 executes various kinds of procedures (e.g. implementing the technique to be described in detail below with reference to FIGS. 3 to 13 and 15) and other available functions. The hard disk 140 stores many kinds of information such as operating systems (OS), various kinds of applications, control programs, sample images, neural networks obtained by training, predefined data (e.g. threshold values (THs)) or the like.

In one implementation, the input device 150 is used to enable a user to interact with the hardware configuration 100. In one example, the user can input a sample image and a label of the sample image (e.g. area information of the object, category information of the object, etc.) via the input device 150. In another example, the user can trigger the corresponding processing of the present invention via the input device 150. Further, the input device 150 can adopt a plurality of kinds of forms, such as a button, a keyboard or a touch screen.

In one implementation, the output device 160 is used to store the final neural network obtained by training in the hard disk 140 for example, or is used to output the finally generated neural network to subsequent image processing such as object detection, object classification, image segmentation, etc.

The network interface 170 provides an interface for connecting the hardware configuration 100 to a network. For example, the hardware configuration 100 can perform a data communication with other electronic devices that are connected by a network via the network interface 170. Alternatively, the hardware configuration 100 may be provided with a wireless interface to perform a wireless data communication. The system bus 180 can provide a data transmission path for mutually transmitting data among the CPU 110, the RAM 120, the ROM 130, the hard disk 140, the input device 150, the output device 160, the network interface 170, etc. Although being referred to as a bus, the system bus 180 is not limited to any specific data transmission technique.

The above hardware configuration 100 is only illustrative and is in no way intended to limit the present disclosure, its application or uses. Moreover, for the sake of simplification, only one hardware configuration is illustrated in FIG. 1. However, a plurality of hardware configurations may also be used as required. For example, the teacher neural network (i.e., the first neural network) in the neural network can be trained by one hardware structure, and the student neural network (i.e., the second neural network) in the neural network can be trained by another hardware structure, wherein these two hardware structures can be connected by a network. In such case, the hardware structure for training the teacher neural network can be implemented by for example a computer (e.g. a cloud server), and the hardware structure for training the student neural network can be implemented by for example an embedded device, such as a camera, a video camera, a personal digital assistant (PDA) or other suitable electronic devices.

### Apparatus and Method for Training the Neural Network

Next, by taking an example of implementing by one hardware configuration, the training of the neural network according to the present disclosure will be described with reference to FIGS. 2 to 10.

FIG. 2 is a configuration block diagram schematically illustrating an apparatus 200 for training a neural network according to an embodiment of the present disclosure. Wherein, a part of or all of modules shown in FIG. 2 can be implemented by specialized hardware. As shown in FIG. 2, the apparatus 200 includes an output unit 210 and an update unit 220.

In the present disclosure, the neural network obtained by training by the apparatus 200 includes a first neural network and a second neural network. Hereinafter, a case where the first neural network is the teacher neural network and the second neural network is the student neural network is described as an example. However, apparently, the present disclosure is not limited thereto. In the present disclosure, training of the teacher neural network has not yet completed and training of the student neural network does not start, that is to say, the teacher neural network for which training does not start or training has not yet completed is trained together with the student neural network for which training does not start in parallel at the same time.

At first, for example, the input device 150 shown in FIG. 1 receives an initial neural network, a sample image and a label of the sample image input by a user. Wherein the input initial neural network includes an initial teacher neural network and an initial student neural network. Wherein the input label of the sample image contains real information of the object (e.g. area information of the object, category information of the object, etc.). Next, the input device 150 transfers the received initial neural network and sample image to the apparatus 200 via a system bus 180.

Then, as shown in FIG. 2, for the current teacher neural network and the current student neural network, the output unit 210 obtains the first output by subjecting the received sample image to the current teacher neural network, and obtains the second output by subjecting the received sample image to the current student neural network. Wherein, the first output includes for example a first processing result and/or a first sample feature, and the second output includes for example a second processing result and/or a second sample feature.

The update unit 220 updates the current teacher neural network according to the first loss function value, and updates the current student neural network according to the second loss function value. Wherein, the first loss function value is obtained according to the first output, and the second loss function value is obtained according to the first output and the second output.

In the present disclosure, the current teacher neural network has been updated n times at most with respect to its previously one updated state, wherein n is less than a total number of times (e.g. N times) that the teacher neural network needs to be updated. The current student neural network has been updated once at most with respect to its previously one updated state. Wherein, in order to improve the performance (e.g. accuracy) of the student neural network, preferably, n is 1 for example. In such case, each update operation of the teacher neural network and each update operation of the student neural network are executed in parallel at the same time, such that the student neural network can imitate and learn the training process of the teacher neural network step by step.

In addition, the update unit 220 further judges whether the updated teacher neural network and student neural network satisfy a predetermined condition, e.g. the needed total number of updates (for example, N times) that have been completed or the predetermined performance that have been achieved. If the teacher neural network and the student neural network have not yet satisfied the predetermined condition, the output unit 210 and the update unit 220 executes the corresponding operation again. If the teacher neural network and the student neural network have satisfied the predetermined condition, the update unit 220 transfers, via the system bus 180 shown in FIG. 1, the finally generated neural network to the output device 160, so as to store the final neural network obtained by training in the hard disk 140 for example, or to output the generated neural network to subsequent image processing such as object detection, object classification, image segmentation, etc.

The method flow chart 300 shown in FIG. 3 is a corresponding procedure of the apparatus 200 shown in FIG. 2. Similarly, the neural network obtained by training through the method flow chart 300 includes the first neural network and the second neural network. Hereinafter, a case where the first neural network is the teacher neural network and the second neural network is the student neural network is also described as an example. However, apparently, the present disclosure is not limited thereto. Similarly, in the method flow chart 300, training of the teacher neural network has not yet completed and training of the student neural network does not start, that is to say, the teacher neural network for which training does not start or training has not yet completed is trained together with the student neural network for which training does not start in parallel at the same time. As stated in FIG. 2, the current teacher neural network has been updated n times at most with respect to its previously one updated state, wherein n is less than a total number of times (e.g. N times) that the teacher neural network needs to be updated. The current student neural network has been updated once at most with respect to its previously one updated state. Hereinafter, a case where each update operation of the teacher neural network and each update operation of the student neural network are executed in parallel at the same time is also described as an example, i.e., n is 1. However, apparently, the present disclosure is not limited thereto.

As shown in FIG. 3, for the current teacher neural network and the current student neural network (e.g. the initial teacher neural network and the initial student neural network), in the output step S310, the output unit 210 obtains the first output by subjecting the received sample image to the current teacher neural network, and obtains the second output by subjecting the received sample image to the current student neural network.

In one implementation, in order to enable the student neural network to not only learn the real information of the object in the label of the sample image, but also learn distribution of the processing results of the teacher neural network at the same time, i.e., in order to enable to supervise training of the student neural network using the processing result of the teacher neural network, in the output step S310, the obtained first output is the first processing result by subjecting the sample image to the current teacher neural network, and the obtained second output is the second processing result by subjecting the sample image to the current student neural network. Wherein, the processing results are decided by the tasks that the teacher neural network and the student neural network are used to execute. For example, in a case where the teacher neural network and the student neural network are used to execute an object detection task, the processing result is a detection result (e.g. including a location result and a classification result of the object). In a case where the teacher neural network and the student neural network are used to execute an object classification task, the processing result is a classification result of the object. In a case where the teacher neural network and the student neural network are used to execute an image segmentation task, the processing result is a segmentation result of the object.

Further, in addition to using the processing result of the teacher neural network to supervise training of the student neural network, interlayer information (i.e., feature information) of the teacher neural network can also be used to supervise training of the student neural network. Therefore, in another implementation, in the output step S310, the obtained first output is the first sample feature obtained by subjecting the sample image to the current teacher neural network, and the obtained second output is the second sample feature obtained by subjecting the sample image to the current student neural network. Wherein, the sample features are decided by the tasks that the teacher neural network and the student neural network are used to execute. For example, in a case where the teacher neural network and the student neural network are used to execute an object detection task, the sample feature mainly contains for example location information and category information of the object. In a case where the teacher neural network and the student neural network are used to execute an object classification task, the sample feature mainly contains for example category information of the object. In a case where the teacher neural network and the student neural network are used to execute an image segmentation task, the sample feature mainly contains for example contour boundary information of the object.

Further, in a further implementation, in the output step S310, the obtained first output is the first processing result and the first sample feature obtained by subjecting the sample image to the current teacher neural network, and the obtained second output is the second processing result and the second sample feature obtained by subjecting the sample image to the current student neural network.

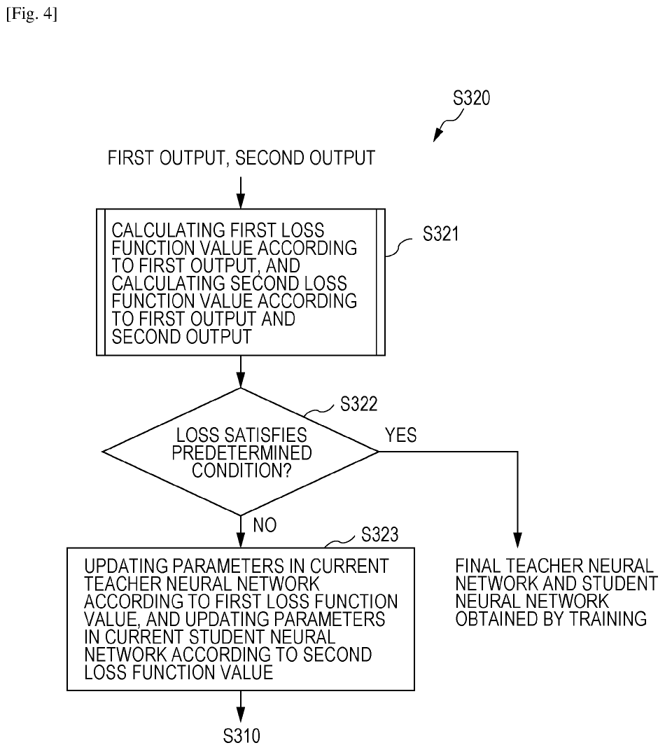

Returning to FIG. 3, in the update step S320, the update unit 220 updates the current teacher neural network according to the first loss function value, and updates the current student neural network according to the second loss function value. Wherein, the first loss function value is obtained according to the first output obtained in the output step S310, and the second loss function value is obtained according to the first output and the second output obtained in the output step S310. In one implementation, the update unit 220 executes the corresponding update operation with reference to FIG. 4.

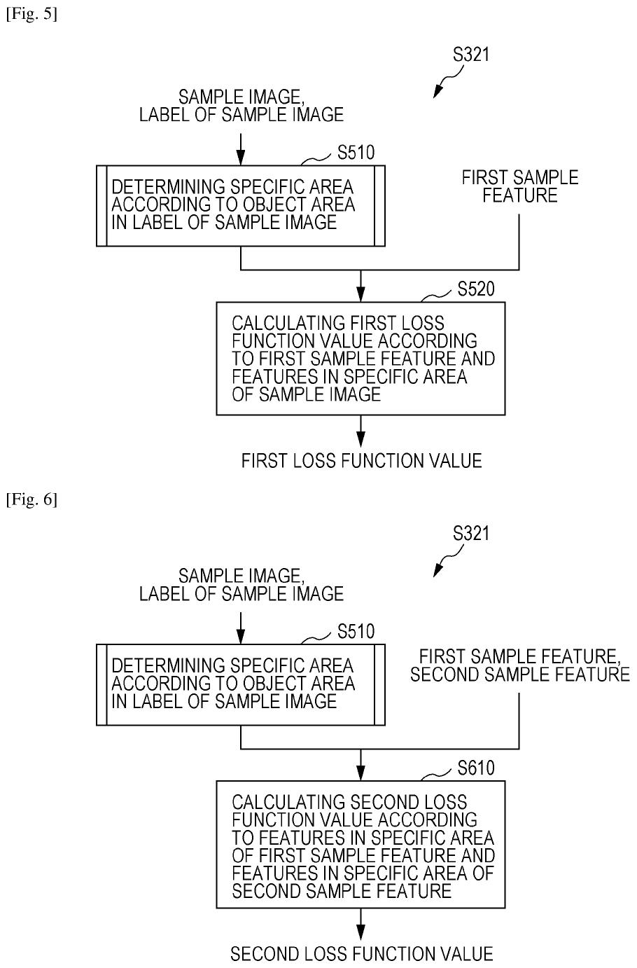

As shown in FIG. 4, in step S321, the update unit 220 calculates the first loss function value according to the first output obtained in the output step S310 as the current teacher neural network, and calculates the second loss function value according to the first output and the second output obtained in the output step S310 as the current student neural network. Hereinafter, calculation of the loss function value applied to the present disclosure will be described in detail below with reference to FIGS. 5 to 10.

In step S322, the update unit 220 judges whether the current teacher neural network and the current student neural network satisfy a predetermined condition according to the loss function value obtained by calculation in step S321. For example, the first loss function value is compared with a threshold value (e.g. TH1), and the second loss function value is compared with another threshold value (e.g. TH2), wherein TH1 and TH2 can be the same or different; in a case where the first loss function value is smaller than or equal to TH1 and the second loss function value is smaller than or equal to TH2, the current teacher neural network and the current student neural network are judged to satisfy the predetermined condition and are output as the final neural network obtained by training, wherein the final neural network obtained by training is for example output to the hard disk 140 shown in FIG. 1. In a case where the first loss function value is larger than TH1 and the second loss function value is larger than TH2, the current teacher neural network and the current student neural network are judged to not satisfy the predetermined condition yet, the procedure proceeds to step S323.

In step S323, the update unit 220 updates parameters of each layer of the current teacher neural network according to the first loss function value obtained by calculation in step S321, and updates parameters of each layer of the current student neural network according to the second loss function value obtained by calculation in step S321. Wherein, the parameters of each layer herein are for example weighted values in each convolution layer of the neural network. In one example, the parameters of each layer are updated using for example the stochastic-gradient-descent method based on the loss function value. After that, the procedure re-proceeds to the output step S310 shown in FIG. 3.

In the flow S320 shown in FIG. 4, whether the loss function value satisfies the predetermined condition is used as a condition to stop updating the neural network. However, apparently, the present disclosure is not limited thereto. Alternatively, step S322 can be omitted for example, and the corresponding update operation is stopped after the number of times of updating the current teacher neural network and the current student neural network reaches a predetermined total number of times (e.g. N times).

Hereinafter, calculation of the loss function value applied to the present disclosure will be described in detail below with reference to FIGS. 5 to 10.

As the above description for FIG. 3, in a case where the first output obtained in the output step S310 is the first processing result and the second output is the second processing result, in step S321 shown in FIG. 4, for calculation of the first loss function value, the update unit 220 calculates the first loss function value according to a real result in the label of the sample image and the first processing result. For calculation of the second loss function value, the update unit 220 calculates the second loss function value according to a real result in the label of the sample image, the first processing result and the second processing result. Specifically, on one hand, the update unit 220 calculates one loss function value (e.g. Loss1) according to a real result in the label of the sample image and the second processing result; on the other hand, the update unit 220 takes the first processing result as the real result, and calculates another loss function value (e.g. Loss2) according to the taken real result and the second processing result; after that, the update unit 220 obtains the second loss function value by summing or weighted summing the two loss function values (i.e., Loss1 and Loss2).

As stated above, the processing results (i.e., the first processing result and the second processing result) are decided by the tasks that the teacher neural network and the student neural network are used to execute. Therefore, the loss functions for calculating the loss function values will also be different depending on different tasks to be executed. For example, for the foreground and background discrimination task, the object classification task and the image segmentation task in the object detection, since the processing results of these tasks belong to the probabilistic output, on one hand, the above Loss2 can be calculated by the Kullback-Leibler (KL) loss function or the Cross Entropy loss function, so as to supervise training of the student neural network by the teacher neural network (taken as the network output supervision), wherein the above Loss2 indicates a difference between the predicted probability value output via the current teacher neural network and the predicted probability value output via the current student neural network. On the other hand, the above first loss function value and the above Loss1 can be calculated by the target loss function, wherein the above first loss function value indicates a difference between the real probability value in the label of the sample image and the predicted probability value output via the current teacher neural network, and wherein the above Loss1 indicates a difference between the real probability value in the label of the sample image and the predicted probability value output via the current student neural network.

Wherein, the above KL loss function, for example, can be defined as the following formula (1):

$$[ Math . 1 ]$$

$${D}_{KL} ( {p}_{t} \vert \vert {p}_{s} ) = {\sum }_{i = 1}^{N} {\sum }_{m = 1}^{M} {p}_{t}^{m} ( {x}_{i} ) log \frac{{p}_{t}^{m} ( {x}_{i} )}{{p}_{s}^{m} ( {x}_{i} )} \qquad ( 1 )$$

Wherein, the above Cross Entropy loss function, for example, can be defined as the following formula (2):

$$[ Math . 2 ]$$

$$L ( {p}_{t} \vert \vert {p}_{s} ) = - {\sum }_{i = 1}^{N} {\sum }_{m = 1}^{M} {p}_{t}^{m} ( {x}_{i} ) log ( {p}_{s}^{m} ( {x}_{i} ) ) \qquad ( 2 )$$

In the above formula (1) and the formula (2), N indicates a total number of the sample images, M indicates a number of category, pₜ^{m}(xᵢ) indicates a probability output of the current teacher neural network for the i-th sample image and the m-th category, pₛ^{m}(xᵢ) indicates a probability output of the current student neural network for the i-th sample image and the m-th category.

Wherein, the above target loss function, for example, can be defined as the following formula (3):

$$[ Math . 3 ]$$

$${L}_{CE} = - {\sum }_{i = 1}^{N} {\sum }_{m = 1}^{M} I ( {y}_{i} , m ) log ( {p}^{m} ( {x}_{i} ) ) \qquad ( 3 )$$

In the above formula (3), y indicates a real probability value in the label of the i-th sample image, and I indicates an indicator function as shown in the formula (4) for example:

$$[ Math . 4 ]$$

$$I ( {y}_{i} , m ) = \{ \begin{matrix}1 & {y}_{i} = m \\ 0 & {y}_{i} \neq m\end{matrix} \qquad ( 4 )$$

For example, for a location task in the object detection, since the processing result thereof belongs to a regressive output, the above first loss function value, the above Loss1 and the above Loss2 can be calculated by the GIoU (General Intersection-over-Union) loss function or the L2 loss function. Wherein the above first loss function value indicates a difference between the real area position of the object in the label of the sample image and the predicted area position of the object output via the current teacher neural network, wherein the above Loss1 indicates a difference between the real area position of the object in the label of the sample image and the predicted area position of the object output via the current student neural network, and wherein the above Loss2 indicates a difference between the predicted area position of the object output via the current teacher neural network and the predicted area position of the object output via the current student neural network.

Wherein, the above GIoU loss function, for example, can be defined as the following formula (5):

L_{GIOU}=1−GIOU . . . (5)

In the above formula (5), GIOU indicates a general intersection-over-union, which can be defined as the following formula (6) for example:

$$[ Math . 5 ]$$

$$GIOU = \frac{A ⋂ B}{A ⋃ B} - \frac{C - ( A ⋃ B )}{C} \qquad ( 6 )$$

In the above formula (6), A indicates a predicted area position of the object output via the current teacher/student neural network, B indicates a real area position of the object in the label of the sample image, and C indicates a minimum bounding rectangle of A and B.

Wherein, the above L2 loss function, for example, can be defined as the following formula (7):

$$[ Math . 6 ]$$

$${L}_{2} = \frac{1}{2 N} {\sum }_{i = 1}^{N} {( {x}_{i} - {x}_{i}^{′} )}^{2} \qquad ( 7 )$$

In the above formula (7), N indicates a total number of objects in one piece of sample image, xᵢ, indicates a real area position of the object in the label of the sample image, and xᵢ′ indicates a predicted area position of the object output via the current teacher/student neural network.

As the above description for FIG. 3, in a case where the first output obtained in the output step S310 is the first sample feature and the second output is the second sample feature, in step S321 shown in FIG. 4, for calculation of the first loss function value, the update unit 220 executes the corresponding calculation operation with reference to FIG. 5.

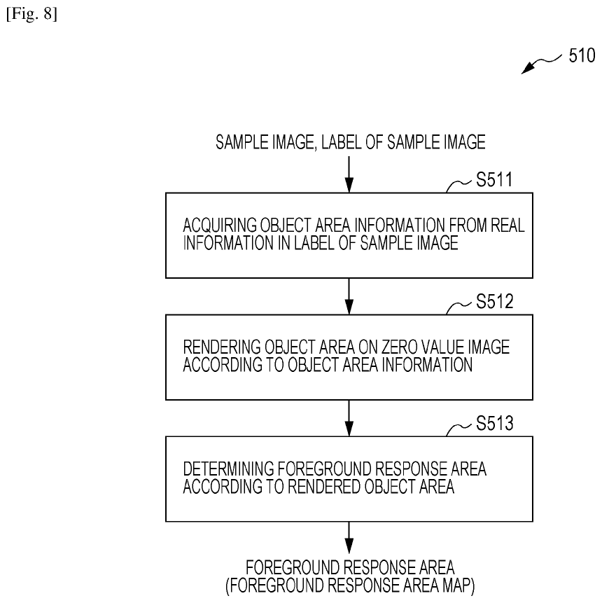

As shown in FIG. 5, in step S510, the update unit 220 determines a specific area (in the present disclosure, the specific area is for example the foreground response area) according to the object area in the label of the sample image, thereby obtaining a foreground response area feature map. Wherein, scale transformation can be carried out for the foreground response area feature map to make its size consistent with the size of the first sample feature (i.e., the feature map). Hereinafter, determination of the specific area (i.e., the foreground response area) applied to the present disclosure will be described in detail below with reference to FIGS. 8 to 10.

In step S520, the update unit 220 calculates the first loss function value according to the first sample feature and the foreground response feature map (i.e., features in the foreground response area). Specifically, the update unit 220 takes the foreground response feature map as the real label, and calculates the first loss function value according to the taken real label and the first sample feature. For example, the first loss function value can be calculated by the L2 loss function, and the first loss function value indicates a difference between the real label (i.e., the foreground response feature) and the predicted feature (i.e., the first sample feature) output via the current teacher neural network. Wherein, the L2 loss function, for example, can be defined as the following formula (8):

$$[ Math . 7 ]$$

$${L}_{2} = \frac{1}{2 {N}_{P}} {\sum }_{i = 1}^{W} {\sum }_{j = 1}^{H} {\sum }_{c = 1}^{C} {( {r}_{ijc} - {t}_{ijc} )}^{2} \qquad ( 8 )$$

In the above formula (8), W indicates widths of the first sample feature and the foreground response feature map, H indicates heights of the first sample feature and the foreground response feature map, C indicates a total channel number of the first sample feature and the foreground response feature map, t_{ijc} , indicates the foreground response feature and r_{ijc} indicates the first sample feature.

Further, as the above description for FIG. 3, in a case where the first output obtained in the output step S310 is the first sample feature and the second output is the second sample feature, in step S321 shown in FIG. 4, for calculation of the second loss function value, the update unit 220 calculates the second loss function value according to the first sample feature and the second sample feature in one implementation. Specifically, the update unit 220 takes the first sample feature as the real label, and calculates the second loss function value according to the taken real label and the second sample feature. For example, the second loss function value can also be calculated by the L2 loss function, and the second loss function value indicates a difference between the real label (i.e., the first sample feature obtained via the current teacher neural network) in the sample image and the predicted feature (i.e., the second sample feature) output via the current student neural network. Wherein, the L2 loss function, for example, can also be defined as the above formula (8), and at this time, t_{ijc} indicates the first sample feature and r_{ijc} indicates the second sample feature.

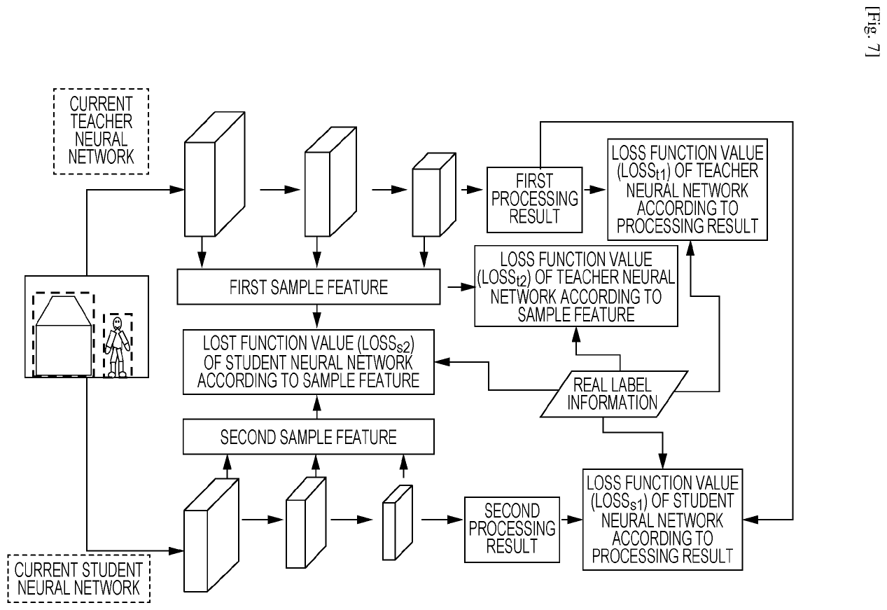

In another implementation, in order to control the student neural network to merely learn features in the specific area of the teacher neural network and thus supervise training of the student neural network by the teacher neural network (taken as interlayer information supervision), the update unit 220 calculates the second loss function value with reference to FIG. 6, such that feature distribution of the student neural network in the specific area can be closer to feature distribution of the teacher neural network, thereby improving the performance (e.g. accuracy) of the student neural network.

The flow shown in FIG. 6 differs from the flow shown in FIG. 5 in that: the update unit 220, after determining the specific area (i.e., the foreground response area) in step S510, calculates the second loss function value according to features in the specific area of the first sample feature and the second sample feature in step S610. Specifically, the update unit 220 takes features in the foreground response area of the first sample feature as the real label, takes features in the foreground response area of the second sample feature as the predicted feature, and calculates the second loss function value according to the taken real label and the taken predicted feature. For example, the second loss function value can be calculated by the defined L2 loss function, and the second loss function value indicates a difference between features in the foreground response area of the first sample feature and features in the foreground response area of the second sample feature. Wherein, the defined L2 loss function, for example, can be defined as the following formula (9):

$$[ Math . 8 ]$$

$${L}_{2} = \frac{1}{2 {N}_{P}} {\sum }_{i = 1}^{W} {\sum }_{j = 1}^{H} {\sum }_{c = 1}^{C} {{E}_{ij} ( {r}_{ijc} - {t}_{ijc} )}^{2} \qquad ( 9 )$$

In the above formula (9), Eᵢⱼ indicates the foreground response area (i.e., the specific area) determined in step S510, and meaning of other parameters in the formula (9) is the same as that of the corresponding parameters in the formula (8), which will not be described in detail below.

As the above description for FIG. 3, in a case where the first output obtained in the output step S310 is the first processing result and the first sample feature and the second output is the second processing result and the second sample feature, in step S321 shown in FIG. 4, for calculation of the first loss function value, the update unit 220 can obtain the final first loss function value by summing or weighted summing the loss function value (Lossₜ₁ as shown in FIG. 7) obtained by calculation according to the first processing result and the loss function value (Lossₜ₂as shown in FIG. 7) obtained by calculation according to the first sample feature. For calculation of the second loss function value, the update unit 220 can obtain the final second loss function value by summing or weighted summing the loss function value (Lossₛ₁ as shown in FIG. 7) obtained by calculation according to the second processing result and the loss function value (Lossₛ₂ as shown in FIG. 7) obtained by calculation according to the second sample feature.

Hereinafter, determination of the specific area (i.e., the foreground response area) executed in step S510 shown in FIGS. 5 and 6 will be described in detail with reference to FIGS. 8 to 10. In one implementation, the update unit 220 executes the corresponding determination operation with reference to FIG. 8.

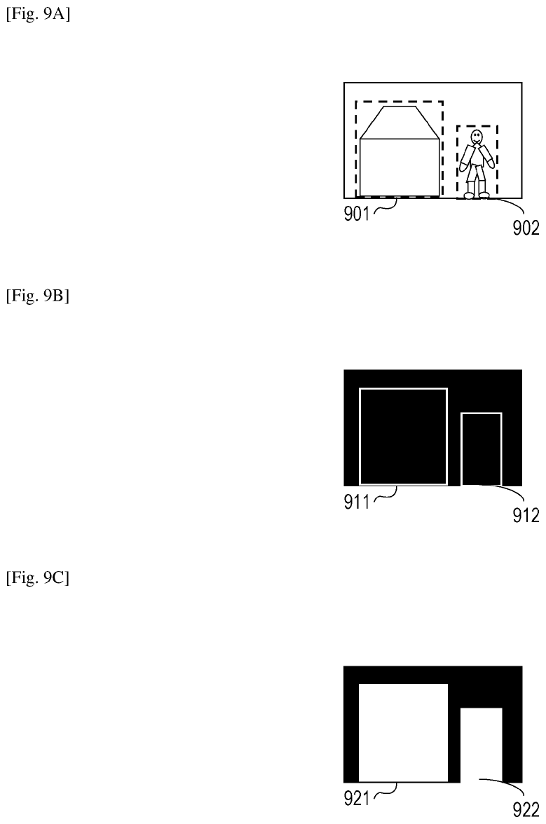

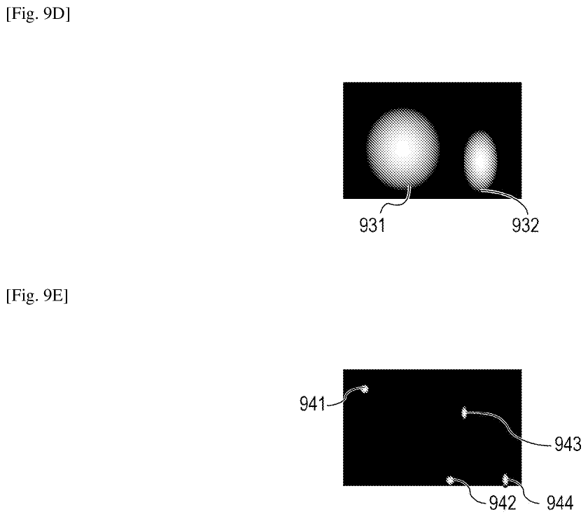

As shown in FIG. 8, the update unit 220 acquires object area information from the real information of the object in the label of the sample image in step S511, for example, acquires the length H, the width W and the space coordinate (i.e., center coordinate (x,y)) of the object area. For example, assuming that the image shown in FIG. 9A is the sample image, the dotted line frames 901-902 therein indicate the real information of the object in the label of the sample image.

In step S512, the update unit 220 generates a zero value image having the same size according to the size of the sample image, and correspondingly renders the object area on the zero value image according to the object area information obtained in step S511. For example, the image shown in FIG. 9B is the zero value image, and white frames 911-912 therein indicate the rendered object areas.

In step S513, the update unit 220 determines the foreground response area according to the object area rendered in step S512. In one implementation, the rendered object area can be directly used as the foreground response area, and a pixel value in the rendered object area is set as for example 1, so as to obtain the corresponding foreground response area map. For example, the image shown in FIG. 9C is the foreground response area map, and white rectangular areas 921-922 therein indicate the foreground response areas.

In another implementation, in order to enable the neural networks (i.e., the teacher neural network and the student neural network) to pay more attention to a center area of the object at the time of extracting sample features (i.e., the first sample feature and the second sample feature), for example, Gauss transformation can be carried out for the object area rendered in step S512 to obtain the smooth response area, so as to improve the accuracy of the neural network for the object location, wherein the obtained smooth response area is the foreground response area and the corresponding map is the foreground response area map. For example, the image shown in FIG. 9D is the foreground response area map, and white circular areas 931-932 therein indicate the foreground response areas. Wherein, the above Gauss transformation for example can be implemented by the following formula (10):

$$[ Math . 9 ]$$

$$f ( {x}_{1} , {x}_{2} ) = F ( x ) = \frac{1}{\sqrt{2 π}} \frac{1}{{\vert \sum \vert}^{1 / 2}} {e}^{[ - \frac{1}{2} {( x - μ )}^{r} {\sum }^{- 1} ( x - μ ) ]} \qquad ( 10 )$$

In the above formula (10), μ indicates a central point coordinate of the rendered object area, Σ indicates a covariance matrix of x₁ and x₂, and x indicates a vector consisting of x₁ and x₂. Wherein, in order to enable the rendered object area to be filled maximally, Σ can be calculated by the following formula (11) for example:

$$[ Math . 10 ]$$

$$\sum = [ \begin{matrix}{( W / 2 )}^{2} & 0 \\ 0 & {( H / 2 )}^{2}\end{matrix} ] \qquad ( 11 )$$

In the above formula (11), W indicates a width of the rendered object area, and H indicates a height of the rendered object area.

In a further implementation, in order to enable the neural networks (i.e., the teacher neural network and the student neural network) to pay more attention to a corner point position of the object area, for example, Gauss transformation can be carried out for two opposite angular points (e.g. a top left angular point and a bottom right angular point, or a bottom left angular point and a top right angular point) in the object area rendered in step S512 to obtain the smooth response area of the angular points, so as to improve the accuracy when the neural network is used for the regression task, wherein the obtained smooth response area is the foreground response area and the corresponding map is the foreground response area map. For example, the image shown in FIG. 9E is the foreground response area map, and white circular areas 941-942 therein indicate the foreground response areas. Wherein, the Gauss transformation used herein for example can be implemented by the above formula (10), and wherein, in order to obtain a response area of the angular points, the covariance matrix Σ in the formula (10) for example can be calculated by the following formula (12):

$$[ Math . 11 ]$$

$$\sum = [ \begin{matrix}{A}^{2} & 0 \\ 0 & {A}^{2}\end{matrix} ] \qquad ( 12 )$$

In the above formula (12), A can be a setting value or e/2 for example, wherein e indicates a minimum value in the width and the length of the rendered object area.

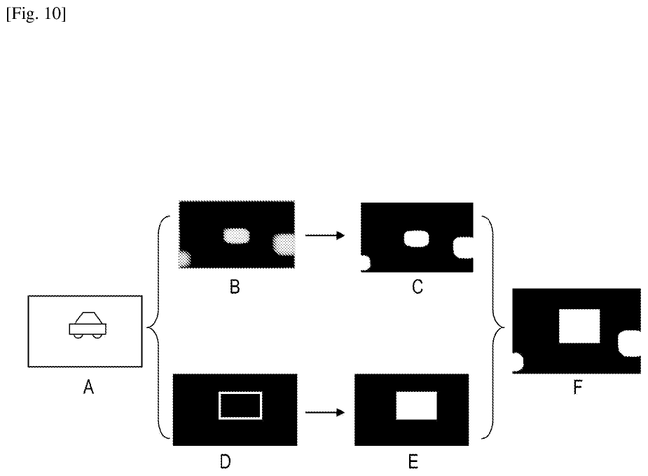

In the flow chart as shown in FIG. 8, the determined specific area (i.e., the foreground response area) is merely obtained according to the object area in the sample image. Since the student neural network has a weaker learning ability, it may produce an erroneous foreground response area in the non-object area portion of the sample image, thereby affecting the performance (e.g. accuracy) of the student neural network. Thus, in order to better avoid/suppress the student neural network to produce an erroneous foreground response area, enabling the student neural network, when the teacher neural network performs interlayer information supervision of training the student neural network, not only learning feature distribution of the teacher neural network in the object area of the sample image, but also learning feature distribution of the position where the student neural network can produce a high response area in the non-object area of the sample image. Thus, as one improvement scheme, after determining the specific area (i.e., the foreground response area) with reference to the flow shown in FIG. 8, the update unit 220 can also further adjust the determined foreground response area according to feature values of the second sample feature (i.e., output in the output step S310 in FIG. 3) obtained by subjecting the sample image to the current student neural network. In the present disclosure, the adjusted foreground response area is called for example as an excitation and suppression area, and the corresponding map is called for example as an excitation and suppression area map. In one implementation, exemplary description is performed below with reference to FIG. 10.

It is assumed that the sample image (i.e., the original image) is as shown in part A of FIG. 10, and the second sample feature map obtained via the output step S310 in FIG. 3 is as shown in part B of FIG. 10, wherein the feature map shown in part B of FIG. 10 is for example a visual feature map, the rendered object area obtained via the flow shown in FIG. 8 is for example as shown by the white frame in part D of FIG. 10, and the specific area (i.e., the foreground response area) obtained via the flow shown in FIG. 8 is for example as shown by the white area in part E of FIG. 10. Wherein, in the implementation, for example, the foreground response area can be called as an “excitation area”, and the map shown in part E of FIG. 10 can be called as an “excitation area map”. At first, for the obtained second sample feature, the update unit 220 determines the high response area from the sample feature. For example, the feature value in the second sample feature can be compared with a predetermined threshold value (e.g. TH3), and an area corresponding to the feature for which the feature value is larger than or equal to TH3 in the second sample feature is determined as the high response area. The high response area determined according to the second sample feature shown in part B of FIG. 10 is for example as shown by the white area in part C of FIG. 10. Wherein, in the implementation, for example, the high response area can be called as a “suppression area”, and the map shown in part C of FIG. 10 can be called as a “suppression area map”. Wherein, TH3 can be set according to the actual application. Then, the update unit 220 can merge the above obtained “excitation area” and “suppression area”, and uses the obtained merged area as the excitation and suppression area. The obtained excitation and suppression area is for example as shown by the white area in part F of FIG. 10, and the map shown in part F of FIG. 10 can be called as for example an “excitation and suppression area map”.

Further, in a case where the update unit 220 calculates the second loss function value with reference to FIG. 6 and the specific area obtained via step S510 is adjusted as the above “excitation and suppression area”, in step S610, the update unit 220 calculates the second loss function value according to features in the excitation and suppression area of the first sample feature and the second sample feature. Specifically, the update unit 220 takes features in the excitation and suppression area of the first sample feature as the real label, takes features in the excitation and suppression area of the second sample feature as the predicted feature, and calculates the second loss function value according to the taken real label and the taken predicted feature. At this time, the second loss function value indicates a difference between the features in the excitation and suppression area of the first sample feature and features in the excitation and suppression area of the second sample feature. In the present disclosure, in a case where the above “excitation and suppression area” is used, the second loss function value, for example, can be calculated by the following formula (13):

$$[ Math . 12 ]$$

$${L}_{ES} = \frac{1}{{N}_{E} + {N}_{S}} {\sum }_{i = 1}^{W} {\sum }_{j = 1}^{H} {\sum }_{c = 1}^{C} ( {I}_{E} ⋃ {I}_{S}^{c} ) {( {s}_{ijc} - {t}_{ijc} )}^{2} \qquad ( 13 )$$

In the above formula (13), I_{E} indicates the specific area (i.e., the foreground response area and the excitation area) determined in step S510, I_{S}^{C} indicates an area (i.e., the suppression area) corresponding to the high response feature in the non-specific area of the c-th channel in the second sample feature, N_{E} indicates the number of pixel points in I_{E}, N_{S} indicates the number of pixel points in I_{S}^{C}, t_{ijc} indicates a value of pixel points in the first sample feature, s_{ijc} indicates a value of pixel points in the second sample feature, W indicates widths of the first sample feature and the second sample feature, H indicates heights of the first sample feature and the second sample feature, and C indicates the number of channels of the first sample feature and the second sample feature, wherein I_{S}^{C} can be indicated by the following formula (14) for example:

$$[ Math . 13 ]$$

$${I}_{S}^{C} = {⋃}_{x = 1}^{W} {⋃}_{y = 1}^{H} I ( {s}_{C} , α , x , y ) ( ¬ {I}_{E} ) \qquad ( 14 )$$

In the above formula (14),

### ¬I_{E}

indicates non-I_{E}, i.e., indicates the non-excitation area and the non-foreground response area; I(s_{c}, α, x, y) indicates the indicator function as shown in the formula (15) for example:

$$[ Math . 14 ]$$

$$I ( {s}_{C} , α , x , y ) = \{ \begin{matrix}1 & {s}_{xyc} > α \times max ( {s}_{C} ) \\ 0 & {s}_{xyc} \leq α \times max ( {s}_{C} )\end{matrix} \qquad ( 15 )$$

In the above formula (15), s_{c} indicates the C-th channel of the second sample feature; α indicates a threshold value that controls a selection range of the suppression area; when α=0, all

### ¬I_{E}

will be contained; when α=1, all

### ¬I_{E}

will be omitted. As one implementation, α can be set as 0.5. However, apparently, the present disclosure is not limited thereto, but can be set according to the actual application.

As stated above, in the process of training the neural network, the student neural network is trained together with the teacher neural network for which training does not start or training has not yet completed in parallel at the same time in the present disclosure, thereby enabling to supervise and guide training of the student neural network using the training process of the teacher neural network. Therefore, according to the present disclosure, on one hand, since training processes of the teacher neural network and the student neural network are executed in parallel at the same time, the student neural network can understand the training process of the teacher neural network more fully, thereby effectively improving the performance (e.g. accuracy) of the student neural network. On the other hand, since there is no need to train the teacher neural network in advance, but it is trained together with the student neural network in parallel at the same time, the overall training time of the teacher neural network and the student neural network can be reduced greatly.

### Training a Neural Network for Detecting an Object

As stated above, the teacher neural network and the student neural network can be used to execute the object detection task. Hereinafter, one exemplary method flow chart 1100 for training a neural network for detecting an object according to the present disclosure will be described with reference to FIG. 11. Wherein, the apparatus for training the neural network corresponding to the method flow chart 1100 may be the same as the apparatus 200 shown in FIG. 2. Wherein, in the method flow chart 1100, it is assumed that the first output obtained by subjecting the sample image to the current teacher neural network includes the first processing result and the first sample feature, and the second output obtained by subjecting the sample image to the current student neural network includes the second processing result and the second sample feature.

As shown in FIG. 11, for the current teacher neural network and the current student neural network (e.g. the initial teacher neural network and the initial student neural network), in step S1110, the output unit 210 as shown in FIG. 2 obtains the first processing result and the first sample feature by subjecting the received sample image to the current teacher neural network. In step S1120, the output unit 210 obtains the second processing result and the second sample feature by subjecting the received sample image to the current student neural network. Wherein, since the trained neural network is used for object detection, the obtained processing results include for example the object location and the object classification.

In step S1130, the update unit 220 as shown in FIG. 2 determines the specific area according to the object area in the label of the sample image with reference to FIGS. 8 to 10, for example, the above foreground response area or the adjusted foreground response area (i.e., the excitation and suppression area).

In step S1140, on one hand, the update unit 220 calculates the corresponding loss function value (e.g. Lossₜ₁) according to the first processing result as stated above. Wherein, as stated above, the obtained processing results for the object detection include for example the object location and the object classification. Therefore, the loss function value of the object location can be calculated for example using the above GIoU loss function (5), and the object classification loss function value and the foreground and background discrimination loss function value can be calculated for example using the above Cross Entropy loss function (2). On the other hand, the update unit 220 for example calculates the corresponding loss function value (e.g. Lossₜ₂) according to the first sample feature with reference to FIG. 5. Then, the update unit 220 for example obtains the first loss function value by summing or weighted summing Lossₜ₁ and Lossₜ₂.

In step S1150, on one hand, the update unit 220 calculates the corresponding loss function value (e.g. Lossₛ₁) according to the second processing result as stated above. Similarly, the loss function value of the object location can be calculated for example using the above GIoU loss function (5), and the object classification loss function value and the foreground and background discrimination loss function value can be calculated for example using the above Cross Entropy loss function (2). On the other hand, the update unit 220 for example calculates the corresponding loss function value (e.g. Lossₛ₂) according to the second sample feature with reference to FIG. 6. Then, the update unit 220 for example obtains the second loss function value by summing or weighted summing Lossₛ₁ and Lossₛ₂. Further, the methods of calculating the loss function values related in steps S1140-S1150 are merely exemplary. However, the present disclosure is not limited thereto, and the corresponding calculation can be performed by selecting the related schemes in FIGS. 4 to 10 according to the actual application.

In step S1160, the update unit 220 updates the current teacher neural network according to the first loss function value obtained in step S1140, and updates the current student neural network according to the second loss function value obtained in step S1150. After the updated teacher neural network and the updated student neural network satisfy the predetermined condition, the finally obtained neural network for detecting an object is output.

As stated above in the FIG. 10, the specific area determined via step S1130 in FIG. 11 can be the excitation and suppression area, and the corresponding map is the excitation and suppression map. In such case, the example of calculating and obtaining the final first loss function value and the final second loss function value is as shown in FIG. 12. In the example shown in FIG. 12, it is assumed that the first sample feature obtained via the teacher neural network is merely used to interlayer supervise training of the student neural network, and the first loss function value for updating the teacher neural network is merely obtained by calculation according to the first processing result. However, apparently, the present disclosure is not limited thereto. The first loss function value can be obtained by simultaneous calculation according to the first processing result and the first sample feature as FIG. 11.

As shown in FIG. 12, in order to make the number of feature maps output by the student neural network consistent with that of the teacher neural network, one extra 1×1 convolution branch is added to the last convolution layer under each down sampling of the student neural network, thereby making the output thereof as the feature map (i.e., the sample feature) output of the student neural network. However, apparently, the present disclosure is not limited thereto. As long as the number of feature maps output by the student neural network is enabled to be consistent with that of the teacher neural network, for example, one extra 1×1 convolution branch can also be added to the last convolution layer under each down sampling of the teacher neural network. As stated above with reference to FIGS. 8 and 10, the specific area (such as the “excitation map” shown in FIG. 12) determined according to the object area in the label of the sample image can be adjusted according to the second sample feature (such as the “heat map” shown in FIG. 12) obtained by subjecting the sample image to the current student neural network, so as to obtain the excitation and suppression area map. Moreover, as stated above, in terms of the sample feature output, the corresponding loss function value L_{ES} (such as ES Loss shown in FIG. 12) can be calculated according to the features in the excitation and suppression area of the first sample feature and the second sample feature through the above formulae (13) to (15). Further, as stated above, in terms of the processing result output, for the current student neural network, on one hand, the corresponding loss function value can be calculated based on the real information in the label of the sample image. e.g. the loss function value L_{GIoU2} (such as GIoU₂ Loss shown in FIG. 12) of the object location can be calculated using the above GIoU loss function (5), and the object classification loss function value and the foreground and background discrimination loss function value L_{CE2} (such as CE₂ Loss shown in FIG. 12) can be calculated using the above target loss function (3); on the other hand, the corresponding loss function value can be calculated based on the first processing result output by the current teacher neural network. Similarly, the loss function value L_{GIoUt} (such as GIoUₜ Loss shown in FIG. 12) of the object location can be calculated using for example the above GIoU loss function (5), and the object classification loss function value and the foreground and background discrimination loss function value L(pₜ∥pₛ) (i.e., L_{CEt}) (such as CEₜ Loss shown in FIG. 12) can be calculated using for example the above Cross Entropy function (2). For the current teacher neural network, the corresponding loss function value can be calculated based on the real information in the label of the sample image. Similarly, the loss function value L_{GIoU1} (such as GIoU₁ Loss shown in FIG. 12) of the object location can be calculated using for example the above GIoU loss function (5), and the object classification loss function value and the foreground and background discrimination loss function value L_{CE1} (such as CE₁ Loss shown in FIG. 12) can be calculated using for example the above target loss function (3). Wherein, L_{CE1}, L_{CE2} and L_{CEt} contain the object classification loss function value and also contain the foreground and background discrimination loss function value. Therefore, the first loss function value and the second loss function value can be obtained by for example summing or weighted summing the related loss function values. For example, the first loss function value can be obtained by the following formula (16), and the second loss function value can be obtained by the following formula (17):

the first loss function value=L_{CE1}+L_{GIoU1} (16)

the second loss function value=L_{ES}+L_{CE2}+L(pₜ∥pₛ)+L_{GIoU2}+L_{GIoUt} (17)

### Training a Neural Network for Image Segmentation

As stated above, the teacher neural network and the student neural network can be used to execute the image segmentation task. According to the present disclosure, one exemplary flow chart for training a neural network for image segmentation is the same as the flow chart shown in FIG. 11, and as for the specific content, no detailed descriptions will be given. The main difference is as follows:

On one hand, in step S1130, for the object detection task, the specific area is determined according to the object area in the label of the sample image. For the image segmentation task, the specific area is determined according to the object contour obtained by the object segmentation information in the label of the sample image.

On the other hand, for the image segmentation task, the processing results obtained via the teacher neural network and the student neural network are image segmentation results. Therefore, when the obtained loss function value is calculate according to the processing results, the classification loss function value of each pixel point can be calculated using the above Cross Entropy loss function (2) for example.

### Training a Neural Network for Object Classification

As stated above, the teacher neural network and the student neural network can be used to execute the object classification task. Hereinafter, one exemplary method flow chart 1300 for training a neural network for object classification according to the present disclosure will be described with reference to FIG. 13. Wherein, the apparatus for training the neural network corresponding to the method flow chart 1300 may be the same as the apparatus 200 shown in FIG. 2.

By comparing the method flow chart 1300 shown in FIG. 13 with the method flow chart 1100 shown in FIG. 11, it can be known that steps S1310-S1320 and S1340-S1360 shown in FIG. 13 are similar with steps S1110-S1120 and S1140-S1160 shown in FIG. 11, and thus no detailed descriptions will be given. In step S1330 shown in FIG. 13, since the object area information is not contained in the real information of the object in the label of the sample image as for the object classification task, the specific area will not be determined according to the object area. Thus, in step S1330, the specific area can be determined directly according to the first sample feature obtained by subjecting the sample image to the current teacher neural network. For example, the area corresponding to the feature for which the feature value is larger than or equal to a predetermined threshold value (e.g. TH4) in the first sample feature can be determined as the specific area.

In addition, for the object classification task, the processing results obtained via the teacher neural network and the student neural network are object classification results. Therefore, when the obtained loss function value is calculate according to the processing results, the classification loss function value can be calculated using the above Cross Entropy loss function (2) for example.

### System for Training a Neural Network

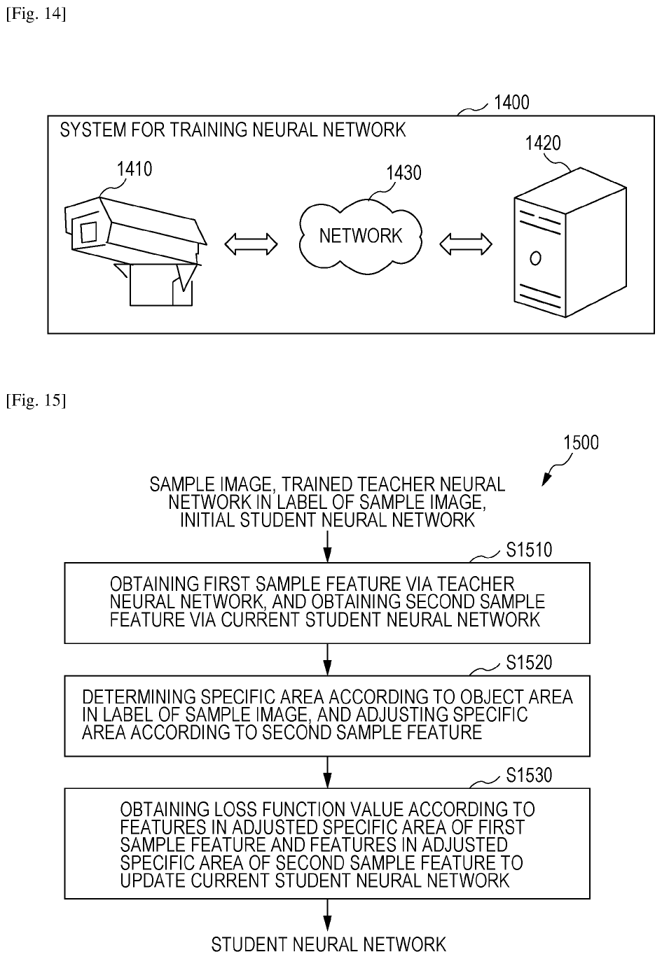

As stated in FIG. 1, as one application of the present disclosure, training of the neural network according to the present disclosure will be described below with reference to FIG. 14 by taking an example of implementing by two hardware configuration.

FIG. 14 is a configuration block diagram schematically illustrating a system 1400 for training a neural network according to an embodiment of the present disclosure. As shown in FIG. 14, the system 1400 includes an embedded device 1410 and a cloud server 1420, wherein the embedded device 1410 and the cloud server 1420 are connected to each other via a network 1430. Wherein, the embedded device 1410 for example can be an electronic device such as a video camera or the like, and the cloud server for example can be an electronic device such as a computer or the like.

In the present disclosure, the neural network obtained by training by the system 1400 includes a first neural network and a second neural network. Wherein, the first neural network is for example a teacher neural network, and the second neural network is for example a student neural network. However, apparently, the present invention is not limited thereto. Wherein, training of the teacher neural network is executed in the cloud server 1420, and training of the student neural network is executed in the embedded device 1410. In the present disclosure, training of the teacher neural network has not yet completed, that is to say, the teacher neural network for which training does not start or training has not yet completed is trained together with the student neural network in parallel at the same time. In the present disclosure, for the current teacher neural network and the current student neural network, the system 1400 executes the following operations:

The embedded device 1410 transmits a feedback to the network 1430, which is used to search an idle cloud server (e.g. 1420) to realize end-to-end guiding learning;

The cloud server 1420, after receiving the feedback from the embedded device 1410, executes the related process (e.g. operation relating to the teacher neural network in the output step S310 and the update step S320 shown in FIG. 3) of the present disclosure, thereby updating the current teacher neural network and obtaining the first output (e.g. including the first processing result and/or the first sample feature);

The cloud server 1420 broadcasts the first output to the network 1430;

The embedded device 1410, after receiving the first output from the cloud server 1420, executes the related process (e.g. operation relating to the student neural network in the output step S310 and the update step S320 shown in FIG. 3) of the present disclosure, thereby obtaining the second output (e.g. including the second processing result and/or the second sample feature) and updating the current student neural network.

### Another Method of Training a Neural Network

As stated above with reference to FIGS. 2 to 14, training of the teacher neural network (i.e., the first neural network) has not yet completed and training of the student neural network (i.e., the second neural network) does not start, that is to say, in FIGS. 2 to 14, the teacher neural network for which training does not start or training has not yet completed is trained together with the student neural network (i.e., the second neural network) for which training does not start in parallel at the same time.

As one application of the present disclosure, the teacher neural network can be trained first in accordance with the general technique, and then training of the student neural network can be guided and supervised by the teacher neural network according to the present disclosure. FIG. 15 is a flow chart 1500 schematically illustrating another method of training a neural network according to an embodiment of the present disclosure. Wherein, the apparatus for training the neural network corresponding to the method flow chart 1500 may be the same as the apparatus 200 shown in FIG. 2.

As shown in FIG. 15, for the current student neural network (e.g. the initial student neural network), the output unit 210, in the output step S1510, obtains the first sample feature by subjecting the received sample image to the trained teacher neural network, and obtains the second sample feature by subjecting the sample image to the current student neural network.

In step S1520, the update unit 220 determines the specific area according to the object area in the label of the sample image, and adjusts the determined specific area according to the second sample feature obtained in the output step S1510 to obtain the adjusted specific area. In this step, the specific area (i.e., the foreground response area) can be determined with reference to FIGS. 8 to 9E for example. In this step, the determined specific area can be adjusted with reference to FIG. 10 for example, wherein the adjusted specific area is the above excitation and suppression area.

In the update step S1530, the update unit 220 updates the current student neural network according to the loss function value, wherein the loss function value is obtained according to features in the adjusted specific area of the first sample feature and features in the adjusted specific area of the second sample feature. In this step, the loss function value can be calculated with reference to the above formulae (13) and (14) for example.

Further, steps S1510-S1530 will be repeatedly executed until the student neural network satisfies the predetermined condition.

All the above units are illustrative and/or preferable modules for implementing the processing in the present disclosure. These units may be hardware units (such as Field Programmable Gate Array (FPGA), Digital Signal Processor, Application Specific Integrated Circuit and so on) and/or software modules (such as computer readable program). Units for implementing each step are not described exhaustively above. However, in a case where a step for executing a specific procedure exists, a corresponding functional module or unit for implementing the same procedure may exist (implemented by hardware and/or software). The technical solutions of all combinations by the described steps and the units corresponding to these steps are included in the contents disclosed by the present application, as long as the technical solutions constituted by them are complete and applicable.

The methods and apparatuses of the present invention can be implemented in various forms. For example, the methods and apparatuses of the present invention may be implemented by software, hardware, firmware or any other combinations thereof. The above order of the steps of the present method is only illustrative, and the steps of the method of the present invention are not limited to such order described above, unless it is stated otherwise. In addition, in some embodiments, the present invention may also be implemented as programs recorded in recording medium, which include a machine readable instruction for implementing the method according to the present invention. Therefore, the present invention also covers the recording medium storing programs for implementing the method according to the present invention.

While some specific embodiments of the present invention have been demonstrated in detail by examples, it is to be understood for persons skilled in the art that the above examples are only illustrative and does not limit to the scope of the present invention. In addition, it is to be understood for persons skilled in the art that the above embodiments can be modified without departing from the scope and spirit of the present invention. The scope of the present invention is restricted by the attached Claims.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 201911086516.1, filed Nov. 8, 2019, which is hereby incorporated by reference herein in its entirety.

1. A method of training a neural network comprising a first neural network and a second neural network, characterized in that: training of the first neural network has not yet completed and training of the second neural network does not start, wherein for the current first neural network and the current second neural network, the method comprises:
an output step of obtaining a first output by subjecting a sample image to the current first neural network, and obtaining a second output by subjecting the sample image to the current second neural network; and
an update step of updating the current first neural network according to a first loss function value, and updating the current second neural network according to a second loss function value, wherein the first loss function value is obtained according to the first output, and the second loss function value is obtained according to the first output and the second output.

2. The method according to claim 1, wherein,
the current first neural network has been updated once at most with respect to its previous state; and
the current second neural network has been updated once at most with respect to its previous state.

3. The method according to claim 1, wherein,
the first output includes a first processing result obtained by subjecting the sample image to the current first neural network; and
the second output includes a second processing result obtained by subjecting the sample image to the current second neural network.

4. The method according to claim 3, wherein, in the update step, the second loss function value is calculated according to a real result in a label of the sample image, the first processing result and the second processing result.

5. The method according to claim 3, wherein,
the first output includes a first sample feature obtained by subjecting the sample image to the current first neural network; and
the second output includes a second sample feature obtained by subjecting the sample image to the current second neural network.

6. The method according to claim 5, wherein, in the update step, the second loss function value is calculated according to the first sample feature and the second sample feature.

7. The method according to claim 5, wherein, in the update step, the second loss function value is calculated according to features in a specific area of the first sample feature and features in the specific area of the second sample feature; and
wherein, the specific area is determined according to an object area in a label of the sample image.

8. The method according to claim 7, wherein, the specific area is one of the object area, a smooth response area of the object area and a smooth response area at a corner point of the object area.

9. The method according to claim 7, wherein, the specific area is adjusted according to a feature value of the second sample feature.

10. The method according to claim 9, wherein, the adjusted specific area is a merged area formed by an area corresponding to a feature for which the feature value is larger than or equal to a predetermined threshold value in the second sample feature and the specific area.

11. The method according to claim 9, wherein, the second loss function value indicates a difference of features in the adjusted specific area of the first sample feature and the second sample feature.

12. The method according to claim 11, wherein, the second loss function value is calculated by the following formula:
$${L}_{ES} = \frac{1}{{N}_{E} + {N}_{S}} {\sum }_{i = 1}^{W} {\sum }_{j = 1}^{H} {\sum }_{c = 1}^{C} ( {I}_{E} ⋃ {I}_{S}^{c} ) {( {s}_{ijc} - {t}_{ijc} )}^{2}$$
wherein, I_{E} indicates the specific area, I_{S}^{C} indicates an area corresponding to a high response feature in a non-specific area of the c-th channel in the second sample feature, N_{E} indicates the number of pixel points in I_{E}, N_{S} indicates the number of pixel points in I_{S}^{C}, t_{ijc} indicates a value of pixel points in the first sample feature, s_{ijc} indicates a value of pixel points in the second sample feature, W indicates widths of the first sample feature and the second sample feature, H indicates heights of the first sample feature and the second sample feature, and C indicates the number of channels of the first sample feature and the second sample feature.

13. The method according to claim 1, wherein, the first neural network is a teacher neural network, and the second neural network is a student neural network.

14. An apparatus for training a neural network comprising a first neural network and a second neural network, characterized in that: training of the first neural network has not yet completed and training of the second neural network does not start, wherein for the current first neural network and the current second neural network, the apparatus comprises:
an output unit for obtaining a first output by subjecting a sample image to the current first neural network, and obtaining a second output by subjecting the sample image to the current second neural network; and
an update unit for updating the current first neural network according to a first loss function value, and updating the current second neural network according to a second loss function value, wherein the first loss function value is obtained according to the first output, and the second loss function value is obtained according to the first output and the second output.

15. A method of training a neural network comprising a first neural network and a second neural network, wherein training of the first neural network has completed and training of the second neural network does not start, characterized in that: for the current second neural network, the method comprises:
an output step of obtaining a first sample feature by subjecting a sample image to the first neural network, and obtaining a second sample feature by subjecting the sample image to the current second neural network; and
an update step of updating the current second neural network according to a loss function value, wherein the loss function value is obtained according to features in a specific area of the first sample feature and features in the specific area of the second sample feature,
wherein the specific area is determined according to an object area in a label of the sample image; and
wherein the specific area is adjusted according to a feature value of the second sample feature.

16. The method according to claim 15, wherein, the specific area is one of the object area, a smooth response area of the object area and a smooth response area at a corner point of the object area.

17. The method according to claim 15, wherein, the first neural network is a teacher neural network, and the second neural network is a student neural network.

18. A system for training a neural network, comprising a cloud server and an embedded device that are connected to each other via a network, the neural network comprising a first neural network for which training is executed in the cloud server, and a second neural network for which training is executed in the embedded device, characterized in that: training of the first neural network has not yet completed and training of the second neural network does not start, wherein for the current first neural network and the current second neural network, the system executes:
an output step of obtaining a first output by subjecting a sample image to the current first neural network, and obtaining a second output by subjecting the sample image to the current second neural network; and
an update step of updating the current first neural network according to a first loss function value, and updating the current second neural network according to a second loss function value, wherein the first loss function value is obtained according to the first output, and the second loss function value is obtained according to the first output and the second output.

19. A storage medium storing instructions that, when executed by a processor, enable to execute training of a neural network, the neural network comprising a first neural network and a second neural network, characterized in that: training of the first neural network has not yet completed and training of the second neural network does not start, wherein for the current first neural network and the current second neural network, the instructions comprise:
an output step of obtaining a first output by subjecting a sample image to the current first neural network, and obtaining a second output by subjecting the sample image to the current second neural network; and
an update step of updating the current first neural network according to a first loss function value, and updating the current second neural network according to a second loss function value, wherein the first loss function value is obtained according to the first output, and the second loss function value is obtained according to the first output and the second output.
